(19) United States
(12) Patent Application Publication
(10) Pub. No.: US 2013/0254289 A1
(43) Pub. Date: Sep. 26, 2013

(54) METHODS AND SYSTEMS FOR SOCIAL REFERRALS

(71) Applicants: Saro Cutri, Tenafly, NJ (US); Robert Morelli, Tenafly, NJ (US); Arron Kallenberg, Long Island City, NY (US)

(72) Inventors: Saro Cutri, Tenafly, NJ (US); Robert Morelli, Tenafly, NJ (US); Arron Kallenberg, Long Island City, NY (US)

(21) Appl. No.: 13/842,662

(22) Filed: Mar. 15, 2013

Related U.S. Application Data
(60) Provisional application No. 61/613,895, filed on Mar. 21, 2012.

(51) Int. Cl. H04L 12/58

(52) U.S. Cl. CPC H04L 51/32
USPC 709/204

(57) ABSTRACT

Methods and systems for providing referrals within a social network are provided. In some embodiments, a request for a referral may be received from a first user. Referrals may include, for example, referrals for businesses or service providers. A plurality of users may be identified, where the plurality of users are linked to the first user (e.g., directly or indirectly) in a social network. The request may be transmitted to the plurality of users, and at least one referral may be received from at least one of the plurality of users. The received at least one referral may be provided to the first user.

This application claims priority to U.S. Provisional Application No. 61/613,895, filed Mar. 21, 2012, which is incorporated by reference herein in its entirety.

The present disclosure relates to a referral system, and more particularly relates to a social referral system for providing referral requests to and receiving referrals from a network of friends.

### SUMMARY

Methods and systems are provided for providing social referrals. Social referrals may include, for example, suggestions or recommendations of a business or service provider. In some embodiments, social referrals are provided within a social network. For example, a person on a social network may ask friends for a recommendation for a business or personal service provider.

In some embodiments, a request for a referral may be received from a first user. A plurality of users linked to the first user in a social network may be identified. The request may be transmitted to the plurality of users, and one or more referrals may be received from the plurality of users in response, and provided to the first user. In some embodiments, the plurality of users may include users with a direct link to the first user in the social network. In some embodiments, the plurality of users may include users with a direct link and a first order indirect link to the first user in the social network. In some embodiments, referrals from a directly linked user and referrals from an indirectly linked user may be received, and may be simultaneously displayed. In some embodiments, requests for personal service provider referrals are received. In some embodiments, the plurality of users is identified based on demographic information. In some embodiments, a communication channel is provided between the first user and a service provider, such as an electronic message. In some embodiments, incentives are provided for users to provide referrals. In some embodiments, multiple referrals are provided to the first user, some of which may include referrals provided to other users for a similar request.

### BRIEF DESCRIPTION OF THE FIGURES

The above and other features of the present disclosure, its nature and various advantages will be more apparent upon consideration of the following detailed description, taken in conjunction with the accompanying drawings in which:

FIG. 1 shows an illustrative system for implementing a referral system in accordance with some embodiments of the present disclosure;

FIG. 2 shows an illustrative block diagram of a referral system in accordance with some embodiments of the present disclosure;

FIG. 3 shows an illustrative display of a referral system including Ask pages in accordance with some embodiments of the present disclosure;

FIG. 4 shows an illustrative display of a referral system including Respond pages in accordance with some embodiments of the present disclosure;

FIG. 5 shows an illustrative display of a referral system including Refer pages in accordance with some embodiments of the present disclosure;

FIG. 6 shows an illustrative display of a referral system including a Community page in accordance with some embodiments of the present disclosure;

FIG. 7 shows an illustrative display of a referral system including a Profile page in accordance with some embodiments of the present disclosure;

FIG. 8 shows an illustrative display of a referral system including My Friends pages in accordance with some embodiments of the present disclosure;

FIG. 9 shows an illustrative display of a referral system including a My Questions page in accordance with some embodiments of the present disclosure; and

FIG. 10 shows an illustrative display of a referral system including a My Referrals page in accordance with some embodiments of the present disclosure.

### DETAILED DESCRIPTION OF THE FIGURES

The referral system in accordance with the present disclosure may provide an “ask and answer” referral service where users can obtain information related to service providers in a social context. The system may provide a platform where users can “Ask” or request a referral. The system may provide a platform where users can “Answer” or recommend businesses and service providers. The system may provide a platform for social interactions related to referrals. The system may provide a platform where referrals go to and requests come from pre-defined connections within a social network.

In some embodiments, the system may include a social network. A social network will be understood to include a network or web of connections between individual users. A social network may include “friends,” where two users have a link (e.g., a direct link) between them that establishes a virtual friendship. A social network may also include “friends of friends,” where two users have a link (e.g., an indirect link) through a mutual friend. An indirect link through a single mutual friend may be referred to as a first order indirect link. An indirect link through two or more mutual friends may be referred to as a second or higher order indirect link. The presence of a friendship between two users (e.g., direct and/or indirect) may be used, for example, to control what information about a first user is available to a second user, what messages may be sent from a first user or on behalf of a first user to a second user, availability of other information (e.g., mutual friend lists, other friend lists, previous referrals), any other suitable information, or any combination thereof.

In some embodiments, friendships may include following such that any user may follow another user. Following, as used herein, is understood to represent a subscription to the actions made by a particular user within the system. Following may be understood to be a form of a virtual friendship. For example, a first user may opt to follow a second user. The second user may receive notification that they are being followed by the first user. The second user may have the option to follow the first user in response, resulting in a bilateral connection. The second user may have the option to not follow in response, resulting in a unilateral connection. The second user may have the option to block the first user from following. In an example of unilateral following, a celebrity may have many more followers than the number of people they follow. In an example of bilateral following, a user with mostly reciprocated, mutual connections will have the same or nearly the same number of followers as the number of people they follow.

In some embodiments, the system may use bilateral connections. The system may allow a first user to request a friend connection with a second user. The second user may then receive notice of the request through the system. The second user may then accept or approve the friend connection, resulting in a bilateral connection. In some cases, the second user may decide to decline or ignore the friend connection, resulting in no connection.

In some embodiments, the system may establish a social network, where users are entities linked by friendships. Users may create a Profile page containing information about themselves, for example, name, location, interests, and previous referrals. In some embodiments, the user may identify other users on the network with whom he or she may wish to establish a friendship. In some embodiments, users may find connections through friends or friends of friends. In some embodiments, users may identify other users by searching a database or list. In some embodiments, a first user may search for the email address of the second user. In some embodiments, the first user may invite the second user to a friendship by sending them a message (e.g., email, chat, text message). In some embodiments, the first user may invite a user who is not a member of the social network to join the network by an external invitation. External invitations may include emails, text messages, messages on other social networks (e.g., Facebook), any other suitable contact information, or any combination thereof.

In some embodiments, the system may retrieve social contacts from an external information source and use that information, in part, to establish a social network. For example, the system may retrieve a first user's email contact list. The list may be retrieved from a personal computer file, from a web-based email or address book application, from any other suitable source, or any combination thereof. In some embodiments, the system may compare the contact list with established members of the social network. The system may send a request for a friend connection to identified users. In some embodiments, the system may invite users to join the social network (e.g., by email) who are identified in the first user's contacts but are not a member of the social network. In some embodiments, the user may review the contact list before requests for friend connections are sent to add or remove individuals.

In some embodiments, the system may retrieve friend connections from a second, external social network. For example, the user may have an established network of friends on a social networking site (e.g., Facebook, LinkedIn). The system may retrieve the first user's list of friend connections from that site and use those contacts to establish friendships on the referral social network system. In some embodiments, this retrieval may require authorization from the user, from the external site, from the user via their account on the external site, from any other suitable party, or any combination thereof.

In some embodiments, the system may be integrated into an external social network (e.g., Facebook, LinkedIn). Many social network sites provide an application programming interface (API) and invite development of applications that integrate into an existing network. The system may include an application that is embedded into an external network (e.g., Facebook Apps). In some embodiments, integration into an existing social network by an application may allow the referral system to use the established network of friends on the external network for the referral system. In some embodiments, integration into an existing social network may allow the use of a social network messaging service (e.g., Facebook chat, Facebook message) for the referral system.

In some embodiments, the system may be available to users as a website. The website may be accessed by any data enabled computer, phone, tablet, other suitable user device, or any combination thereof. In some embodiments, the system may be available on a user device by a standalone application. For example, a smartphone application may allow access on a smartphone device and may be optimized for a device with a particular screen size and user input capabilities (i.e., touchscreen, keyboard). In some embodiments, the system may include different applications for tablet computers than for smartphones due to the increased screen size. In some embodiments, the system may also include email, text messaging (SMS), multimedia messaging (MSM), any other suitable communication methods, or any combination thereof.

In some embodiments, the system may provide a platform for a user to request a referral. The user may request a referral based on the service provided, the location, the time, the cost, any other suitable criteria, or any combination thereof. The request for referral may include a written, unstructured description as well. The request for referral may include a photograph, video, or audio message. For example, a picture of a broken sink may be included in a request for a plumber referral. In some embodiments, the request may be communicated to the user's friends, friends of friends, users within a particular geographical area, users with a particular referral history, users with any other suitable characteristics, or any combination thereof.

In some embodiments, the system may provide a platform for users to refer service providers. The system may include solicited referrals, which may be received from users in response to a referral request. The system may include unsolicited referrals, which may be received from users not in response to any particular request. The system may provide referrals directly to a user in response to a request, may store them in a searchable database, may process them in any other suitable technique, or any combination thereof. In some embodiments, service providers may offer an incentive to users for referrals. For example, incentives may include discounts, promotions, monetary payments, any other suitable incentive, or any combination thereof.

In some embodiments, the system may provide a platform for a community interaction page. For example, a Community page may include recent requests and referrals from friends. The Community page may include special offers and promotions from vendors.

In some embodiments, the system may transmit referral requests to other users. For example, requests may be broadcast using the Community page, an in-site messaging service, email, SMS, a third party messaging service (e.g., Facebook Message), any other suitable service, or any combination thereof. In some embodiments, referral requests may be provided using any suitable third party software (e.g., in a panel on a Facebook page) or any other suitable software (e.g., as a widget or gadget implemented on a computer). In some embodiments, requests (e.g., an email notification) may be sent out immediately as requests are received, in a digest form, in any other suitable form, or any combination thereof. Transmitting a digest may include compiling requests received over a predefined period of time (e.g., daily, weekly), or compiling requests after a predefined number of requests are received (e.g., after every 5, 10, 20 requests), and sending a single email containing the compiled requests. In some embodiments, where the system is implemented on a mobile device, push notifications may be used to alert a user of a request. In some embodiments, the system may transmit a message to a select group of people depending on contextual information related to the user. Contextual information may include friend connections to the user requesting the service. For example, the system may transmit a message to friends or both friends and friends-of-friends. Contextual information may include age, sex, geographic location, any other suitable demographic information, and any combination thereof. In some embodiments, geographic constraints may depend upon the service requested. For example, a user requesting a plumber may request a service provider within a limited distance, while a user requesting an accountant may not require geographic restrictions. In a further example, a request for childcare services may only be sent to users with children. In a further example, a request for an OB/GYN doctor may only be sent to women. In a further example, a request for dog groomers may only be sent to dog owners within a particular geographic area. As an example, a dog groomer request from a user in Cincinnati may not be sent to a friend in San Francisco. In some embodiments, referrals may be transmitted based on previous interactions with the system. For example, a user who has previously requested a particular service may receive a referral request for the same service. In a further example, a user who has previously recommended a service provider may receive a request for that same service. For example, a user who has previously requested or received a referral related to dog groomers may receive a dog groomer referral request. In some embodiments, contextual information may be obtained or provided by the user, the system based on the content of the request, by any other suitable technique, or any combination thereof. In some embodiments, the system may receive criteria from the requesting user related to transmitting the request. For example, the system may receive information about how far a user is willing to travel for the services. In a further example, the system may receive information related to transmitting a request only to friends or to both friends and friends-of-friends. In some embodiments, the system may receive criteria from users related to desired received requests.

In some embodiments, the system may provide a platform to generate revenue for the referral service. In some embodiments, the system may display advertisements and receive payments from the vendors for the display. In some embodiments, the system may provide service providers with prioritized referral listings in return for payment to the referral service. In some embodiments, the system may receive payment from a service provider when the service provider displays a promotion or special offer on the referral service platform. In some embodiments, the system may provide a user with the ability to purchase or pay for a product or service related to a referral. For example, a movie may be referred by a first user to a second user. The system may enable the second user to purchase a movie theater ticket. In some embodiments, the system may receive payment for the transaction. For example, the system may receive a portion of the transaction amount. In another example, the system may receive a payment in excess of the transaction amount from the user, from the service provider, from the first user offering the referral, from any other suitable entity, or any combination thereof. In some embodiments, the system may maintain a funds balance for a user on the system to fund transactions for goods and services purchased on or through the service. In some embodiments, the system may provide a user with the ability to perform a transaction within the system, may refer users to an external website, may refer users to an email or phone contact, may refer users through any other suitable contact method, or any combination thereof.

In some embodiments, the system may generate a list of service providers that have been referred to users within the system. The system may use the list to target service providers for advertising on the platform. In some embodiments, displayed advertisements may be correlated to the content displayed on the screen or included in a search. For example, a user requesting gardening services may be shown a banner advertisement from a local gardening service in addition to the content of the referrals. The gardening service with the banner advertisement may have been identified by previous referral interactions of users, and then contacted directly by the system or an operator of the system.

In some embodiments, the system may provide a platform for linking referrals with service providers. The system may provide real-time (e.g., chat) or delayed (e.g., email) linking between a user and a service provider identified in a referral request or response. For example, a user may receive a referral for a particular service provider. The system may provide the ability to initiate a chat, email, phone call, instant message, or other communication with the service provider within the referral system application or website. For example, the system may generate an email to the provider by receiving information from the user filling out a form. In a further example, the system may provide a chat service linking the user and the service provider. In some embodiments, establishing communication within the system with a service provider may provide an opportunity for the service provider to offer discounts or promotions. In some embodiments, the system may receive payment from a service provider for providing the chat service or other communication links with users (e.g., service providers may pay a fee for access and/or connections to customers). For example, service providers may pay a particular amount per user referred through the system. In another example, service providers may pay per contact instance or time interval of communication with a user. In some embodiments, payment and pay rates may be based on the services provided, the monetary amount of a transaction that occurs or is expected to occur, the quantity or value of goods or services sold, negotiated rates, any other suitable arrangement, or any combination thereof. In some embodiments, the system may receive from service providers a one-time setup fee, ongoing periodic payments, pre-paid payments, post-paid payments, any other suitable billing arrangement, or any combination thereof. In some embodiments, the service provider may be notified by the system of a referral, customer demand, or other interest. The system may allow the service provider to initiate real-time or delayed communication with a consumer.

In some embodiments, the system may provide a platform for a service provider information or Profile page, where a user can find more information about the services they provide. The Profile page may include recommendations from previous customers, location information, business hours, contact information, photographs, videos, other suitable information, or any combination thereof. In some embodiments, the service provider Profile page may include a link to an external website, such as a website for the service provider. In some embodiments, the service provider information page may provide a dynamic, content-based location for service providers to interact with users. In some embodiments the service provider information page, or any other suitable page, may include discounts, coupons, loyalty bonuses, any other suitable financial incentives, or any combination thereof. For example, the system may allow a service provider to offer to users a 20% off coupon to first time customers. In another example, the system may allow a service provider to offer a discount to customers who have referred other customers.

In some embodiments, the service provider Profile page may include content that is only visible to the service provider. The system may allow the service provider to view statistics and other information on user referrals to their service, statistics and other information on user referrals to their competitors, data analysis, other suitable information, and any combination thereof. In some embodiments, data analysis and other information may allow the service provider to target incentives, discounts, and special offers to certain groups or time periods. For example, a service provider may choose to offer a relatively high discount coupon during a time period when they are receiving a high volume of referrals, and thus expect to recover their costs through increased volume. For example, an umbrella store may see increased referral frequency and choose to increase a discount during a rainy day or week. In a further example, a service provider may provide multiple discount levels based on demand, such as 10% off to the first 10 customers in a given day, 5% off to the next fifty customers, and 0% off to customers after that. In some embodiments, service providers may use the information and data analysis provided by the system on the service provider information page to tailor and adjust discount and incentive programs.

In some embodiments, the system may provide a platform for users to request feedback on a particular service provider. For example, a user may have identified a particular provider using the system or from an external interaction, and may request opinions or feedback regarding that service provider from their friends or other users who have previously used the service provider.

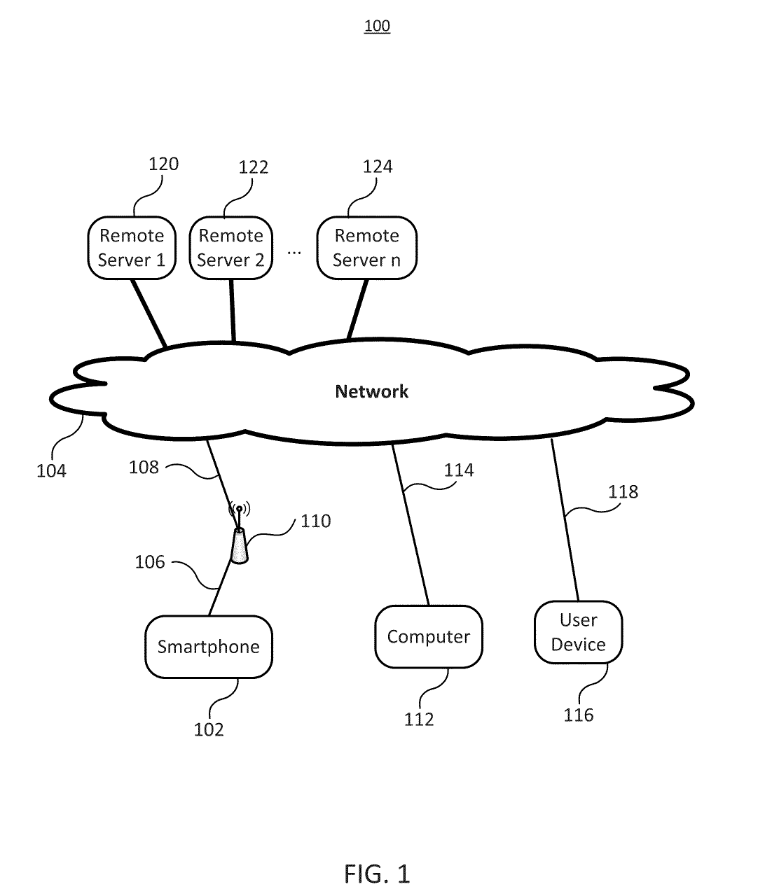

The following description and accompanying FIGS. 1-10 provide additional details and features of some embodiments of the referral system.

FIG. 1 shows an illustrative system for implementing a referral system in accordance with some embodiments of the present disclosure. System 100 may include smartphone 102, computer 112, user device 116, network 104, and remote servers 120, 122, and 124. System 100 may include multiple devices for providing content and communication including any number and combination of smartphone 102, computer 112, and user device 116. Smartphone 102 may include a mobile communication device capable of providing content and communicating data. For example, smartphone 102 may include a cellular and/or WiFi enabled portable device with a display and user input such as a touchscreen or keyboard. Smartphone 102 may include a cellular telephone without a touchscreen that may be used for text messaging, a voice telephone that may be used for a touch-tone system, any other suitable communication device, or any combination thereof. Computer 112 may include a laptop computer, desktop computer, netbook, any other suitable computing device, or any combination thereof. User device 116 may include a tablet, mobile gaming device, internet-enabled media player, any other suitable user device, or any combination thereof. Smartphone 102, computer 112, and user device 116 may include equipment to provide content to a user, equipment to receive input from a user, equipment to carry out processing steps, equipment to communicate with a network, any other suitable equipment, or any combination thereof.

System 100 may include network 104. Network 104 may include the Internet, a private intranet, any other suitable network of coupled computing systems, or any combination thereof. Smartphone 102, computer 112, and user device 116 may be coupled to network 104 using communication equipment including one or more cellular phone towers, RF repeaters, satellites, routers, switches, any other suitable communication device, or any combination thereof. Smartphone 102 may be coupled to network 104 by, for example, GSM cellular connection 106, wireless communication device 110, and wired connection 114. Computer 112 may be connected to network 104 by, for example, Ethernet connection 114. User device 116 may be connected to network 104 by, for example, wireless connection 118.

System 100 may include any suitable number of remote servers. Remote servers coupled to network 104 may include remote server “1” 120, remote server “2” 122, and any suitable number up to remote server “n” 124. Remote servers “1, 2, . . . , n” 120, 122 and 124, respectively, may be coupled to network 104 using any suitable communication technique or combination of communication techniques. A server may be any suitable software, hardware, or both, implemented in one or more computing devices for performing particular functions in a network environment. Servers may include one or more search engines, database servers, index servers, chat servers, video servers, media servers, billing servers, storage servers, multipurpose servers, any other suitable specific use servers, any other suitable general purpose servers, or any combination thereof. Servers may be located in any geographic location in any suitable grouping. In some embodiments, server utilization may be adjusted by the system, or any other suitable control mechanism, based upon load, network traffic, specific tasks, any other suitable criteria, or any combination thereof. Any processing steps may be carried out at least in part on smartphone 102, computer 112, and user device 116, at least in part by the servers coupled to network 104, at least in part by any other suitable processing equipment, or any combination thereof.

Smartphone 102, computer 112, or user device 116 may include a global positioning system (GPS) receiver (not shown) capable of receiving signals from global positioning satellites. In some embodiments, a GPS receiver may receive information from one or more satellites orbiting the earth, the information including time, orbit, and other information related to the satellite. This information may be used to calculate the location of smartphone 102, computer 112, or user device 116, on the surface of the earth. The GPS receiver may include a barometer to improve the accuracy of the location. The GPS receiver may receive information from other wired and wireless communication sources regarding location. For example, the identity and location of nearby cellular phone towers or WiFi connections may be used in place of, or in addition to, GPS data to determine the location of the device.

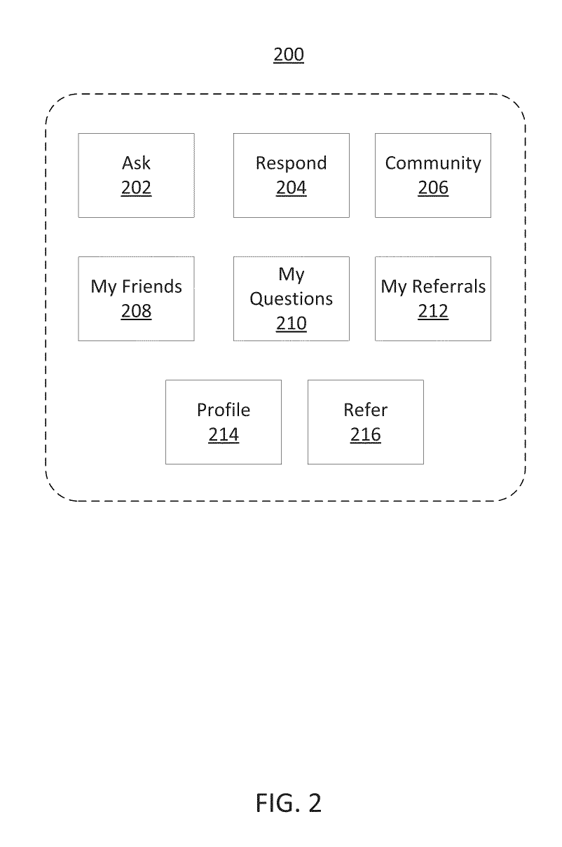

FIG. 2 shows illustrative block diagram 200 of a referral system in accordance with some embodiments of the present disclosure. Block diagram 200 may include modules included in the referral system. In some embodiments, each module may include one or more pages that will be displayed on a smartphone, computer, or user device, such as smartphone 102, computer 112, or user device 116 of FIG. 1. Block diagram 200 may include Ask module 202, Respond module 204, Community module 206, My Friends module 208, My Questions module 210, My Referrals module 212, Profile module 214, and Refer module 216. Linking may be provided in any of the modules to reach any of the other modules. It will be understood that the modules illustrated in block diagram 200 are merely illustrative and that the system may include any suitable modules. It will also be understood that the particular groupings of content within the modules are merely illustrative and that in some embodiments modules may be merged or split in any suitable fashion.

It will be understood that the referral system and its modules may be implemented in any suitable software, firmware, hardware, or combination thereof. For example, the referral system and its modules may include one or more hardware processors (e.g., integrated circuits), one or more software modules, computer-readable media such as memory, firmware, or any combination thereof. In some embodiments, all or some of the referral system and its modules may be referred to collectively as processing equipment.

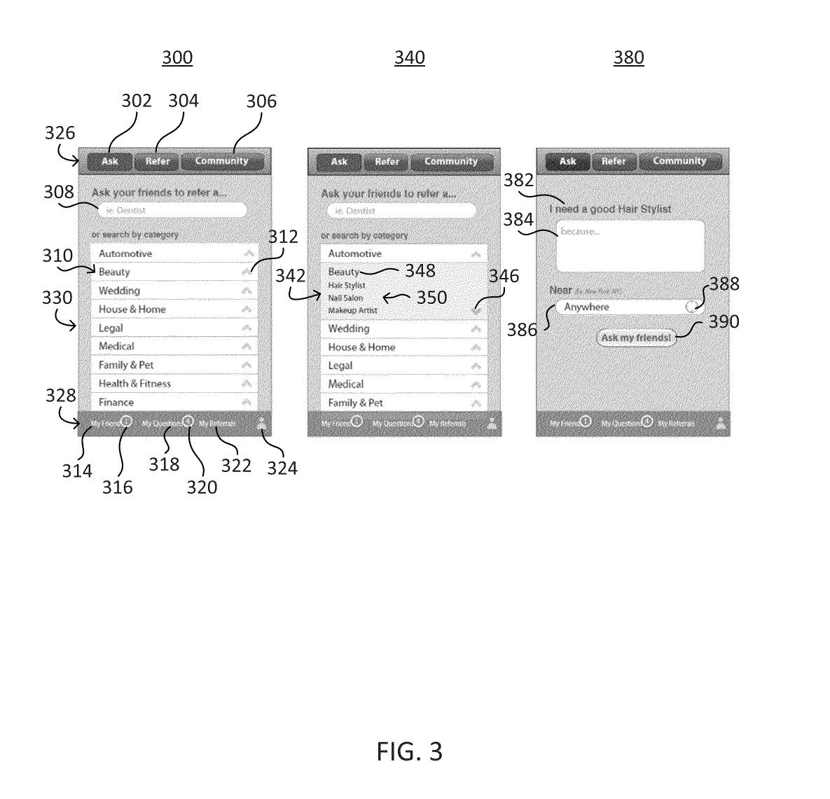

The content and display screens of the individual modules will be described in detail in the following figures. It will be understood that the particular images, shading, layout, design, icons, text, and other elements shown in FIGS. 3-10 are merely exemplary and that any suitable elements may be used. In some embodiments, gray text in a text box may indicate content that will be shown to the user as a prompt and removed when the user begins inputting information.

FIG. 3 shows an illustrative display of a referral system including Ask pages 300, 340, and 380 in accordance with some embodiments of the present disclosure. The Ask pages may be provided by Ask module 202 of FIG. 2. Ask page 300 may include top row navigation 326, central information section 330, and bottom bar navigation 328.

Top row navigation 326 may include Ask button 302, Refer button 304, and Community button 306. The buttons may provide links to other pages within the system and an indicator of the current page. For example, Ask button 302 may be displayed as a depressed button, indicating that the system is displaying the Ask page. Refer button 304 and Community button 306 may be displayed as raised buttons, indicating that user selection of either button will indicate the user's desire to visit the Refer page or Community page, respectively.

Bottom bar navigation 328 may include My Friends link 314, My Questions link 318, My Referrals link 322, and profile link 324. Pending or recent communication events may be indicated in bottom bar navigation 328. For example, a number of recent follower additions may be displayed by a number such as friend indicator 316, associated with My Friends link 314. In the embodiment illustrated in FIG. 3, friend indicator 316 displaying the number 1 may indicate that the user has 1 pending or unviewed notification. Pending or recent questions asked by the user may be indicated by question indicator 320, associated with My Questions link 318. In the embodiment illustrated in FIG. 3, request indicator 320 may indicate that the user has 4 recently asked questions. In some embodiments, request indicator 320 may indicate the number of requests with responses, the number of requests without responses, the total number of requests over a particular time period, any other suitable indicator, or any combination thereof. In some embodiments, an indicator (not shown) may be associated with My Referrals 322. Profile link 324 may link a user to a Profile page including personal information, an account page containing login, password, contact, and other account information, any other suitable personal page, or any combination thereof.

Central information section 330 of Ask page 300 may include information related to asking or requesting a referral. Text box 308 may receive information from the user related to a particular type of service or goods provider. For example, the user may input the name of a service, such as dentist, plumber, acupuncturist, or lawyer. Central information section 330 may include categories of service providers that can be searched in a drill-down menu. For example, the system may receive a selection of Beauty item 310 from the user to indicate that the user is seeking referrals related to beauty services. Indicator 312 may indicate that Beauty item 310 may be expanded. Indicator 312 may include an up arrow when the drill-down section of the menu is compressed and may include a down arrow when the drill-down section of the arrow is expanded. Indicator 312 may not be present when the item is a terminal selection in a selection tree. It will be understood that the arrow shape used for indicator 312 in FIG. 3 and elsewhere is merely illustrative any that any suitable indicators or combination of indicators may be used. In some embodiments, where the display of the user device is not large enough to display the content of central information section 330, the system may receive any suitable swipe, scroll, slide, button click, other input, or any combination thereof, to indicate a desire to redefine the selection of content displayed on the screen.

Ask page 340 includes another view of the Ask page. Expanded beauty section 342 may include an expanded item with sub-categories. For example, Beauty item 310, as illustrated in Ask page 300, may be expanded after the system receives a selection, to show expanded beauty section 342. Expanded beauty section 342 may include top level category 348, and subcategories 350. Subcategories 350 to beauty item 348 may include, for example, Hair Stylist, Nail Salon, and Makeup Artist. In some embodiments, the display text size of subcategories 350 may be smaller than top level category 348. Indicator 346 is illustrated as a down arrow to indicate that expanded beauty section 342 is an expanded display.

In some embodiments, the system may receive a selection of a category or subcategory, either by receiving a search in text box 308, or by receiving a selection of a category or subcategory in central information area 330. The system may display ask screen 380 in response to, for example, receiving a category selection. Ask screen 380 may include category indicator 382. Category indicator 382 may indicate the category selected on a previous page. Ask screen 380 may include text box 384, which may receive textual input from the user including a description or explanation of the referral they are requesting. Input may include further defining information that may be useful for users responding to the request. For example, for a hair stylist, the system may receive input such as “because I need a stylist good with children” or “because I need a stylist good with hair dye.” In some embodiments, Ask screen 380 may enable the user to upload a picture or video related to the referral request (e.g., a picture of a desired hair style or dye color). Ask screen 380 may include location box 386. Location box 386 may receive input from a user indicating where they need the services included in the referral request. Location box 386 may receive location information in the form of an address, a city and state, a zip code, country, GPS coordinates, any other suitable locating information, or any combination thereof. The system may receive the information “anywhere” (as illustrated), or any other suitable indicator of a non-geographically specific request, to indicate that the service provider included in the requested referral may be located anywhere. In some embodiments, GPS indicator 388 may be included in text box 386, or in any other suitable location on Ask screen 380. GPS indicator 388 may retrieve GPS coordinates and use the coordinates to determine content for the text box 386. For example, a GPS-enabled smartphone may determine its location using GPS information, WiFi information, cellular information, any other suitable information, or any combination thereof. In some embodiments, receiving a selection of GPS indicator 388 may cause textual content related to the location to be displayed in text box 386. In some embodiments, the system may receive input from the user to refine the textual content related to the location. For example, the system may receive location-refining input if the user desires to indicate a different location, or if the user elects to provide less specific location information to the system.

Ask page 380 may include Ask My Friends button 390. The system may receive input related to a selection of the Ask My Friends button 390 from the user confirming that the information displayed on Ask page 380 is correct. Receiving the selection of the Ask My Friends button 390 may cause the system to send a referral request to the user's friends, to friends of friends, to any other suitable recipients, or any combination thereof.

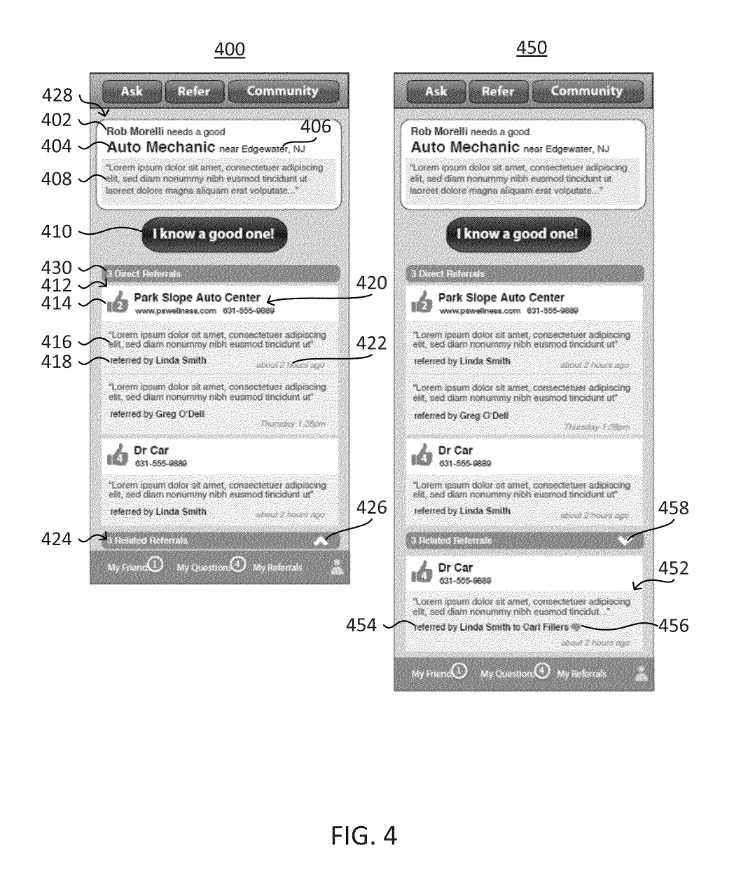

FIG. 4 shows an illustrative display of a referral system including Respond pages 400 and 450 in accordance with some embodiments of the present disclosure. The Respond pages may be provided by Respond module 204 of FIG. 2. The Respond page may be displayed to allow the system to receive input from a user related to recommending a service provider. The user may be brought to the Respond page from a link in a broadcast message (e.g., an email), from the Community page (described below), by any other suitable link, or any combination thereof.

Respond page 400 may include question section 428, direct referral section 412, and related referral section 424. Question section 428 may include name 402, category 404, location 406, and text description 408. Name 402 may include the name of the person requesting the referral. Category 404 may include the category or title description of the requested service. Location 406 may include the location where the service is requested. In some embodiments, location 406 may indicate that the service is not location specific and may be located anywhere. Text description 408 may include a description of the service requested, more information about what is requested, any other suitable information, or any combination thereof. In some embodiments, category 404, location 406, and text description 408 may relate to information received in category indicator 382, text box 384, and location box 386, respectively, of Ask page 380 of FIG. 3.

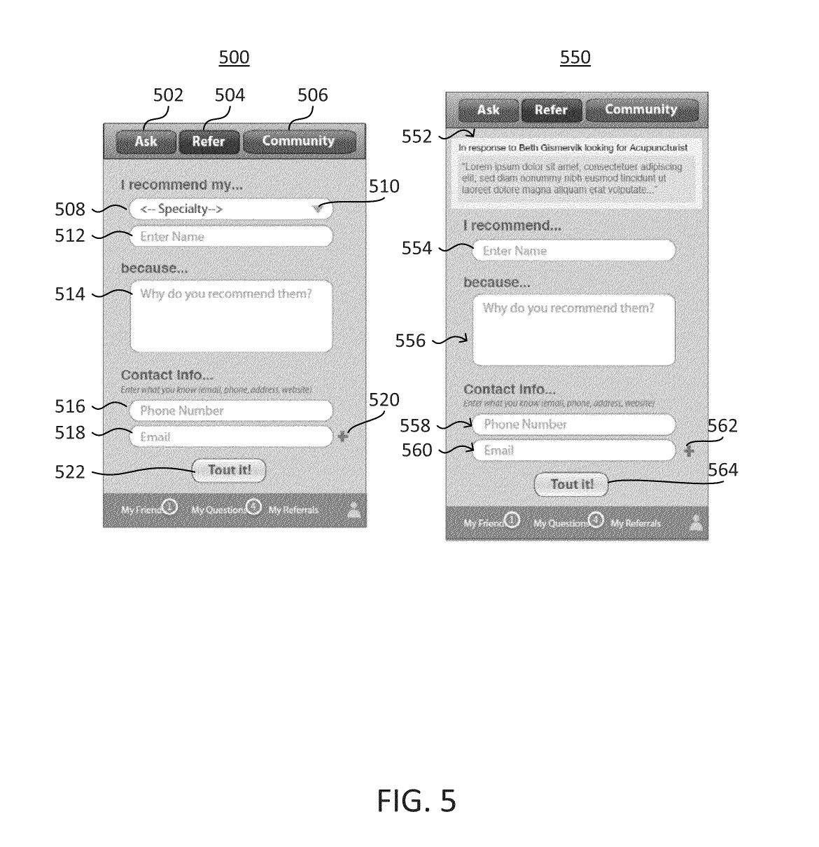

I Know a Good One button 410 may allow a user to refer the asking user to a service provider. In some embodiments, selecting I Know a Good One button 410 may link the user to the Refer page described below in FIG. 5.

Direct referrals section 412 may include referrals offered in response to the request in question section 428. Direct referral count 430 may indicate the number of direct referral sections, such as direct referral section 412, presented in response to the question of question section 428. A direct referral may include referral details 420, describing, for example, the name, website, email (not shown) and phone number of the service provider recommended by the user. In some embodiments, user selection of particular parts of referral details 420 may cause content to be displayed or may initiate software. For example, selecting a phone number may launch a phone dialing program. In a further example, selecting a website URL may launch a web browser. In some embodiments, selecting the name of the service provider may link the user to that service provider's information page within the system. Direct referrals section 412 may include text description 416, referrer 418, and referral time 422. These may provide further information related to the referrals in direct referral section 412. In some embodiments, the format of referral time 422 may change depending on the age of the referral. For example, referral time may be shown in a number of hours for the first 12 hours after it is posted, and may be shown as a time and date following that. Direct referrals section 412 may include vote indicator 414. The vote indicator may indicate that one or more users in addition to (or including) referrer 418 have recommended the service provider, without providing the full description information. In some embodiments, users may give additional confirmation by selecting vote indicator 414. For example, the “2” in vote indicator 414 may indicate that 2 people have indicated their approval of “Linda Smith's” referral to “Park Slope Auto Center.” In some embodiments, vote indicator 414 may indicate the count of referrals with full description information entered for the same service provider. For example, as illustrated in Ask page 400 of FIG. 4, “Park Slope Auto Center” has been recommended by 2 people: “Linda Smith” and “Greg O'Dell.” In some embodiments (not shown), a first vote indicator may indicate the number of referrals for a vendor and a second vote indicator may indicate the number of people who approve a referral. It will be understood that the aforementioned vote indicators are merely exemplary and that any suitable indicator or combination of indicators may be used to provide historical information regarding referrals.

In some embodiments, the system may include related referrals section 424. Direct referrals may indicate referrals in direct response to the question of question section 428. Related referrals may indicate referrals in response to the same or a similar question posted by a different user. For example, related referrals may include recommendations made by friends (or friends of friends) to previously asked questions. Related referrals section 424 may be in a collapsed view initially upon displaying Respond page 400, as indicated by indicator 426. Respond page 450 may display related referral section 424 in an expanded view, as indicated by indicator 458. Related referral 452 may be a referral made for a service provider, for example, in the same category, location, with matching description keywords, with any other suitable criteria, or any combination thereof. The related referral illustrated in Respond page 450 shows in related referrer 454 that the referral was made by “Linda Smith to Carl Fillers,” indicating that the referral was made in response to a question asked by “Carl Fillers” and not in direct response to the question of “Rob Morelli” shown in question section 428. In some embodiments, all available related referrals and/or all information contained in related referrals may not be displayed in Respond page 450. In some embodiments, selecting indicator 456 may link the user to a page containing complete information related to that related referral. In some embodiments, the linked page may include a page where related referral 452 of Respond page 450 is a direct referral.

FIG. 5 shows an illustrative display of a referral system including Refer pages 500 and 550 in accordance with some embodiments of the present disclosure. The Refer pages may be provided by Refer module 216 of FIG. 2. Refer page 500 may receive input from a user related to an unsolicited referral. Refer page 550 may receive input from a user related to a solicited referral. In some embodiments, a user may be brought to Refer page 550 after indicating they have a referral to offer in response to a posted (or solicited) question, for example, after selecting I Know a Good One button 410 of FIG. 4.

Refer page 500 may include top navigation including Ask button 502, Refer button 504, and Community button 506. The system may indicate that the displayed page is a Refer page by showing Refer button 504 as a depressed button. In some embodiments, Refer page 500 may be reached by selecting Refer button 504 on a different page where the top navigation is displayed.

Refer page 500 may include sections to receive input information related to a referred service provider. Category box 508 may receive information to categorize the service provider. Categories may include, for example, the categories shown in central information section 330 of FIG. 3. Input related to pull down indicator 510 may cause the system to display a list of categories for selection by the referrer. In some embodiments, the system may receive textual input related to the category. In some embodiments, the system may search the list of categories using, for example, the first few letters of textual input, such that the entire or exact category title is not required. Name section 512 may receive the name of the service provider. In some embodiments, the system may match the name or part of the name to a list of known service providers. This may, for example, prevent multiple entries for the same service provider with different spellings. This also may, for example, accelerate input by completing the entry for the referrer. In some embodiments, completion suggestions may be based in part on previous entries, geographic location, other suitable information, or any combination thereof. Description section 514 may receive textual input from the referrer describing the service provider, the referrer's experience using the service provider, the referrer's reasons for recommending the service provider, any other suitable information, or any combination thereof. Phone number section 516 may allow the referrer to enter the phone number of the service provider. The system may also receive input related to phone numbers from an established list of contact information, for example, stored on a mobile phone or computer application. The system may also retrieve contact information from external applications such as an email program or web browser. Email section 518 may allow the referrer to enter the email of the service provider. The system may also receive input related to email addresses from an established list of contact information, for example, stored on a mobile phone or computer application. The system may also retrieve email information from external applications such as an email program or web browser. Expand indicator 520 may allow the referrer to add additional contact information sections, such as, for example, a website URL or address. In some embodiments, the system may automatically complete contact information for known service providers. Tout It! button 522 may submit the referral to the system.

Refer page 550 may include sections to receive input from a referrer in response to a solicited referral. For example, the system may receive a request for a referral as illustrated in FIG. 3. Question section 552 may include information from the request including the name of the person requesting the referral, the category, and a description. Name section 554 may receive input from the referrer including the name of a service provider. In some embodiments, Refer page 550 may not include a category input selection box because the category will be assigned as the category indicated by question section 552. Description section 556 may receive textual input from the referrer describing the service provider, the referrer's experience using the service provider, the referrer's reasons for recommending the service provider, any other suitable information, or any combination thereof. Phone number section 558 may allow the referrer to enter the phone number of the service provider. The system may also receive input related to phone numbers from an established list of contact information, for example, stored on a mobile phone or computer application. The system may also retrieve contact information from external applications such as an email program or web browser. Email section 560 may allow the referrer to enter the email of the service provider. The system may also receive input related to email addresses from an established list of contact information, for example, stored on a mobile phone or computer application. The system may also retrieve email information from external applications such as an email program or web browser. Expand indicator 562 may allow the referrer to add additional contact information sections, such as, for example, a website URL or address. In some embodiments, the system may automatically complete contact information for known service providers. Receiving a selection of the Tout it! button 564 may cause the submission of the information to the referral to the system.

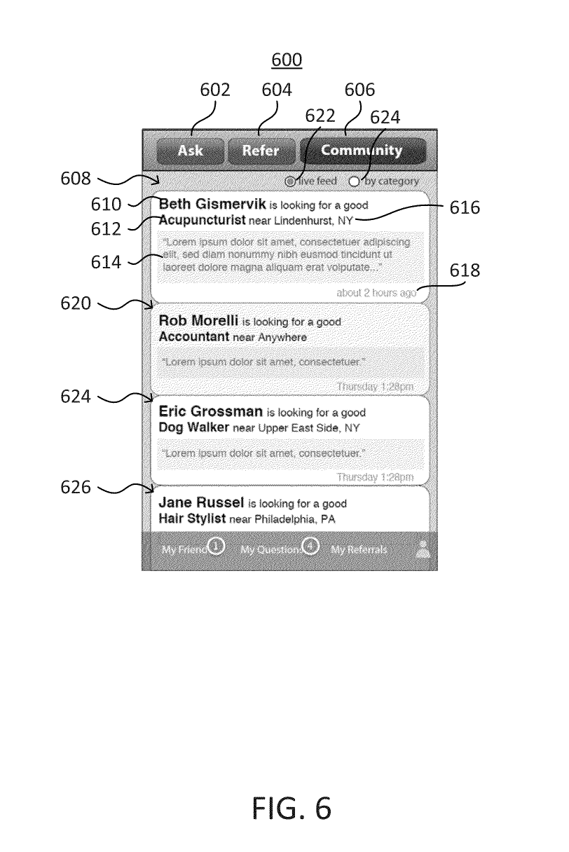

FIG. 6 shows an illustrative display of a referral system including Community page 600 in accordance with some embodiments of the present disclosure. The Community page may be provided by Community module 206 of FIG. 2. Community page 600 may display information related to recent requests for referrals. In some embodiments, the system may display to a user requests from the users friends, from friends-of-friends, from geographically nearby users, from other demographically or otherwise qualified users, or any combination thereof.

Community page 600 may include top navigation including Ask button 602, Refer button 604, and Community button 606. The system may indicate that the displayed page is a Community page by showing Community button 606 as a depressed button. In some embodiments, Community page 600 may be reached by selecting Community button 606 on a different page where the top navigation is displayed. Community page 600 may include live feed radio button 622 and category radio button 624. The system may display a list of the most recent referral requests when live feed radio button 622 is selected, as illustrated in Community page 600. When category radio button 624 is selected, the system may display recent referrals sorted by category. It will be understood that these techniques of displaying recent referrals on the category page are merely exemplary and that other suitable sorting and displaying techniques may be used. For example, requests may be sorted by user, user relation (e.g., friends and friends of friends), geographic location, any other categorization, or any combination thereof.

Community page 600 may include referral requests 608, 620, 624, and 626. A referral request may include, for example, information received in Ask page 380 of FIG. 3. Receiving a selection of a referral request may cause the system to display to the user, for example, solicited referral input of Refer page 550 of FIG. 5. Information included in a referral request may include name 610, category 612, location 616, time 618, and description 614.

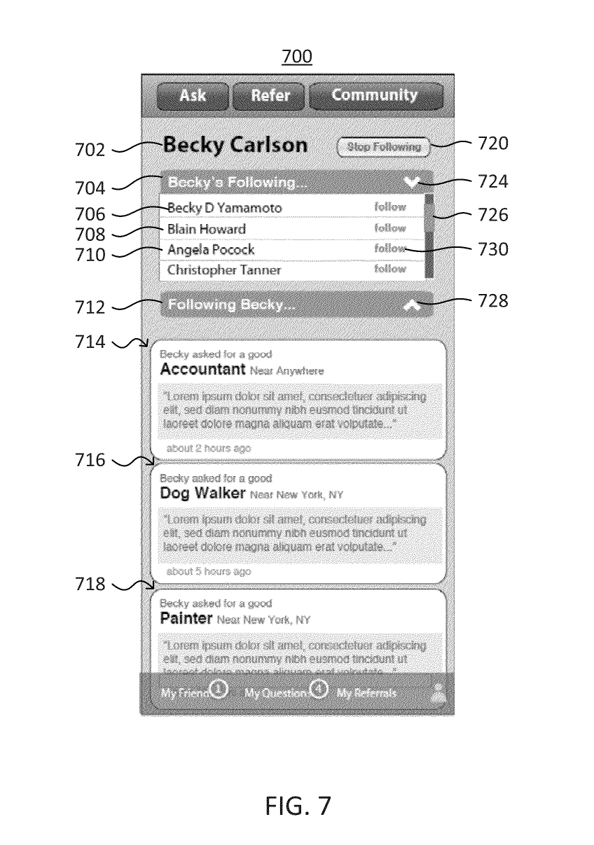

FIG. 7 shows an illustrative display of a referral system including Profile page 700 in accordance with some embodiments of the present disclosure. The user Profile page may be provided by Profile module 214 of FIG. 2. In some embodiments, the system may display the user Profile page of a first user to a second user. For example, the system may display the user Profile page of a user after his or her name is selected on another page. Profile page 700 may include user name 702, list 704 containing other users followed by the user named in name 702, list 712 containing other users following the user named in name 702, and recent referral requests made by the user named in name 702. Following, as used herein, is understood to represent a subscription to the actions made by a particular user within the system. For example, an action made by a particular user may generate a publication item. Publication items may include, for example, referral requests and referrals. Users following a particular user may receive notification of some or all publication items associated with a user that he or she is following. In some embodiments, the system may allow the user to customize the frequency, format, method, and content of follow notifications. In some embodiments, information related to followed friends may be displayed on a page provided by the system. In some embodiments, users may receive an email containing published items from followed friends.

It will be understood that some of the elements illustrated in Profile page 700 are unique to social networks that include unilateral and/or bilateral connections. In some embodiments, there may only be bilateral connections in a network. For example, list 712 may be a list of friends rather than a list of following when there are only bilateral connections. It will be understood that some of the textual elements may be varied based on the use of bilateral and unilateral connections. For example, list 704 may be titled “Friends” rather than “Following” in a bilateral network. In another example, follow link 730 may display “friend,” “connect,” any other suitable text or symbol, or any combination thereof. It will be understood that other suitable modifications may be made to Profile page 700 (and other pages) based on the presence of bilateral connections, unilateral connections, friend-of-friend (and higher order) connections, group/communal connections, any other suitable connections, or any combination thereof.

List 704 of Profile page 700 may include users followed by the user named in name 702. For example, as illustrated in FIG. 7, user 706, user 708, and user 710 may be followed by the user named in name 702. Selecting a user in list 704 may cause the system to display that user's Profile page. Indicator 724 may indicate that list 704 is in an expanded view. Scroll bar 726 may allow the list to be scrolled to view more entries. Follow link 730 may allow a user viewing page 700 to follow the user indicated by, for example, user 710. List 712, showing other users following the user named in name 724, may be in a collapsed view, as indicated by indicator 728. The expanded view of list 712 may include elements similar to the elements of list 704. In an embodiment where most of the following of the user named in name 702 is bilateral, the users contained in list 704 and list 712 may be mostly the same, and so it may be beneficial to have one list default to a collapsed view initially. Stop Following button 720 may allow a user viewing the Profile page of the user named in name 702 to stop following that user (e.g., end friendship).

Profile page 700 may include referrals requested by the user named in name 702. For example, referral request 714, referral request 716, and referral request 718 may be displayed. Referral requests may include information that was entered, for example, in Ask page 380 of FIG. 3. In some embodiments, selecting a referral request, such as referral request 714, referral request 716, or referral request 718, may cause the system to display a Respond page such as that illustrated in FIG. 4, or a Refer page such as that illustrated in FIG. 5. In some embodiments, Profile page 700 may display referrals made by the user named in name 702.

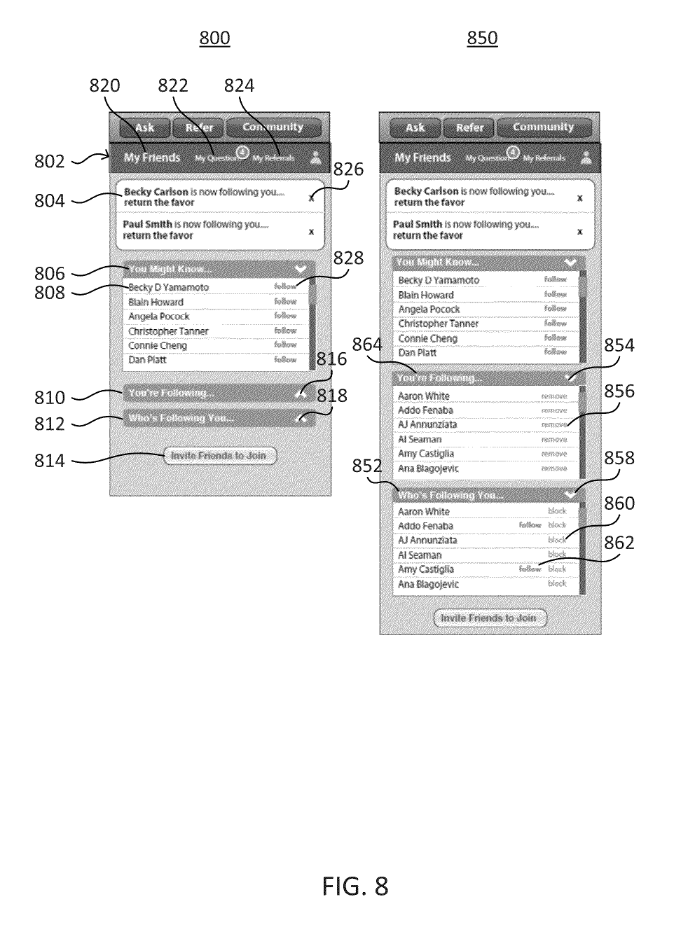

FIG. 8 shows an illustrative display of a referral system including My Friends pages 800 and 850 in accordance with some embodiments of the present disclosure. The My Friends page may be provided by My Friends module 208 of FIG. 2. The My Friends page may be accessed, for example, using My Friends link 314 of bottom bar navigation 328 of FIG. 3. Generally, elements of the bottom bar navigation relate to the current user. In some embodiments, selecting items on the bottom bar navigation may cause the system to display the bottom section sliding up to cover the top, exposing the contained information. In some embodiments, My Friends pages 800 and 850 may include information about a user's social connections. Bottom bar navigation 802 may be displayed near the upper portion of the screen, having moved up from the bottom to display the associated content. Bottom bar navigation may include My Friends link 820, My Questions link 822, and My Referrals link 824. In some embodiments, My Friends link 820 may be displayed with relatively larger text than the other elements of bottom navigation bar 802 to indicate that the displayed content is the My Friends Page.

As described above, it will be understood that suitable modifications to the elements, text, and symbols of FIG. 8 may be made based on the presence of bilateral connections, unilateral connections, friends-of-friends and more distant connections, group/communal connections, any other suitable connections, or any combination thereof. For example, the text “following” may be replaced with “connected” or other suitable text. In another example, list 864 and list 852 of My Friends page 850 may only include a single list when bilateral connections are used.

My Friends page 800 may include new follower 804. New follower 804 may include another user on the system that has added the current user to their follow list. In some embodiments, selecting “return the favor” or any other suitable selection may cause the current user to also follow that user, or “follow back.” This would, for example, create a bilateral following relationship. Selecting “x” indicator 826 may dismiss the message and result in a unilateral following relationship.

My Friends page 800 may include You Might Know list 806. The You Might Know list 806 may include suggested other users for the current user to follow. Suggested other users may be identified as friends of friends, through multiple mutual friendships, by geographic, demographic, or historical information, through information retrieved through a third party (e.g., email contact list, Facebook friend list), by any other suitable technique, or any combination thereof. Selecting Follow link 828 may result in the current user following the selected user.

List 810 and list 812 may be displayed in a collapsed view, as indicated by indicator 816 and indicator 818, respectively. List 810 may include users followed by the current user. List 812 may include users following the current user. Invite Friends to Join button 814 may provide a way for the current user to invite other friends from outside the system. For example, receiving a selection of button 814 may cause the system to display to the current user an email input page. In another example, the system may access contact information from an external application or website, such as a mobile phone contact list or computer email program. In some embodiments, the system may provide the user with the ability to indicate a desired contact frequency. For example, the user may indicate that he or she desires to receive emails daily, weekly, or monthly. In another example, the user may indicate that he or she desires to receive text messages immediately. In another example, the user may indicate that he or she desires to not receive any external contact. In some embodiments, users may be invited through specific question requests. In some embodiments, users may be invited generally without a specific request.

My Friends page 850 is another view of the My Friends page, where list 810 and list 812 are shown in an expanded view. List 864 may be, for example, list 810 of friends followed by the current user shown in an expanded view, as indicated by indicator 854. Selecting Remove link 856 may remove the listed user from the current users list. List 852 may be, for example, list 812 of friends following the current user, show in an expanded view as indicated by indicator 858. Block link 860 may allow the current user to prevent a listed user from viewing the activity or otherwise interacting with the current user. Follow link 862 may allow the current user to establish a bilateral follow relationship with a listed user.

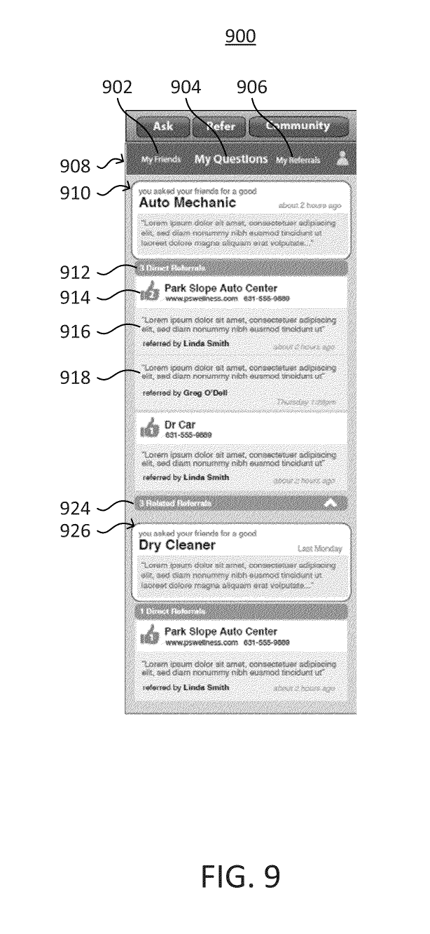

FIG. 9 shows an illustrative display of a referral system including My Questions page 900 in accordance with some embodiments of the present disclosure. The My Questions page may be provided by My Questions module 210 of FIG. 2. The My Questions page may be accessed, for example, using My Questions link 318 of bottom bar navigation 328 of FIG. 3. In some embodiments, selecting items on the bottom bar navigation may cause the system to display the bottom section sliding up to cover the top, exposing the contained information. In some embodiments, My Questions page 900 may include information about a user's previously asked questions (i.e., requested referrals). Bottom bar navigation 908 may be displayed near the upper portion of the screen, having moved up from the bottom to display the associated content. Bottom bar navigation may include My Friends link 902, My Questions link 904, and My Referrals link 906. In some embodiments, My Questions link 904 may be displayed with relatively larger text than the other elements of bottom navigation bar 908 to indicate that the displayed content is the My Friends Page.

My Questions page 900 may include questions previously asked by the current user, for example, question 910 and question 926. Previously asked questions may have been received by, for example, Ask page 380 of FIG. 3. The current user may access My Questions page 900 to, for example, check on responses to questions they may have asked. My questions page 900 may include information similar to that displayed on a Respond page such as Respond Page 400 of FIG. 4. My Questions page 900 may include Direct Referrals list 912, including referrals offered in response to the question posted by the current user. A direct referral may include contact information 914, description 916, and description 918. Contact information 914 may include a vote indicator showing the total number of referrals for a given service provider. My Questions page 900 may include Related Referrals list 924, initially displayed in a collapsed view. Related referrals may include referrals made for a similar request, but not in response to the question posted by the current user.

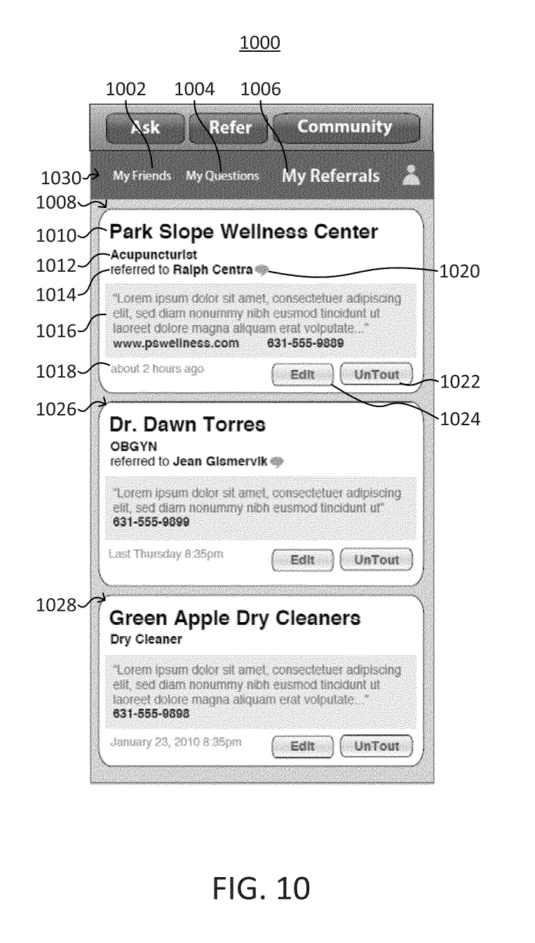

FIG. 10 shows an illustrative display of a referral system including a My Referrals page in accordance with some embodiments of the present disclosure. The My Referrals page may be provided by My Referrals module 212 of FIG. 2. The My Referrals page may be accessed, for example, using My Referrals link 322 of bottom bar navigation 328 of FIG. 3. In some embodiments, selecting items on the bottom bar navigation may cause the system to display the bottom section sliding up to cover the top, exposing the contained information. In some embodiments, My Referrals page 1000 may include information about a user's previously offered referrals. Bottom bar navigation 1030 may be displayed near the upper portion of the screen, having moved up from the bottom to display the associated content. Bottom bar navigation may include My Friends link 1002, My Questions link 1004, and My Referrals link 1006. In some embodiments, My Referrals link 1006 may be displayed with relatively larger text than the other elements of bottom navigation bar 1030 to indicate that the displayed content is the My Referrals Page.

My Referrals page 1000 may include referrals provided by the current user, for example, in Refer pages 500 and 550 of FIG. 5. My Referrals may include solicited referrals 1008 and 1026, and unsolicited referral 1028. Solicited referral 1008 may include service provider name 1010, category 1012, name 1014, description and contact information 1016, time 1018, discussion link 1020, edit button 1022, and UnTout button 1024. Name 1014 may indicate the name of the user who requested the referral. Discussion link 1020 may link the user to a page showing both the requested referral and other responses, such as Respond page 400 of FIG. 4. Edit button 1022 may allow the current user to revise content of solicited referral 1008. UnTout button 1024 may allow the current user to remove solicited referral 1008. Unsolicited referral 1028 may not display a discussion link or a referral requester name. In some embodiments, a user may be able to provide a negative review of a referral.

It will be understood that while the foregoing generally describes the referral system as being used for referring services, the referral system may be used for referring goods, services, stores or shops providing goods and/or services, businesses any other company, person, item, or combination thereof.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods and systems, but is intended to include variations to and modifications thereof, which are within the spirit of the following claims. The following claims may also describe various aspects of this disclosure.

What is claimed:

1. A method for providing referrals within a social network, the method comprising:
receiving a request for a referral from a first user;
identifying a plurality of users, wherein the plurality of users are linked to the first user in a social network;
transmitting the request to the plurality of users;
receiving at least one referral from at least one of the plurality of users; and
providing the at least one referral to the first user.

2. The method of claim 1, wherein identifying the plurality of users comprises identifying users that have a direct link to the first user in the social network.

3. The method of claim 1, wherein identifying the plurality of users comprises identifying users that have a direct link and a first order indirect link to the first user in the social network.

4. The method of claim 3, wherein receiving the at least one referral comprises receiving a first referral from a user that has a direct link to the first user in the social network and a second referral from a user that has a first order indirect link to the first user in the social network.

5. The method of claim 4, wherein providing the at least one referral to the first user comprises simultaneously displaying the first referral and the second referral.

6. The method of claim 1, wherein receiving a request for a referral comprises receiving a request for a personal service provider.

7. The method of claim 1, wherein identifying the plurality of users comprises identifying the plurality of users based on demographic information.

8. The method of claim 1, the method further comprising providing a communication channel between the first user and a service provider related to the request for the referral.

9. The method of claim 1, the method further comprising providing the first user with an incentive from a service provider related to the request for the referral.

10. The method of claim 1, wherein providing the at least one referral to the first user comprises simultaneously displaying the at least one referral and at least one additional referral from the plurality of users that was received prior to receiving the request from the first user.

11. A system for providing referrals within a social network, the system comprising:
processing equipment configured to perform operations comprising:
receiving a request for a referral from a first user;
identifying a plurality of users, wherein the plurality of users are linked to the first user in a social network;
transmitting the request to the plurality of users;
receiving at least one referral from at least one of the plurality of users; and
providing the at least one referral to the first user.

12. The system of claim 11, wherein identifying the plurality of users comprises identifying users that have a direct link to the first user in the social network.

13. The system of claim 11, wherein identifying the plurality of users comprises identifying users that have a direct link and a first order indirect link to the first user in the social network.

14. The system of claim 13, wherein receiving the at least one referral comprises receiving a first referral from a user that has a direct link to the first user in the social network and a second referral from a user that has a first order indirect link to the first user in the social network.

15. The system of claim 14, wherein providing the at least one referral to the first user comprises simultaneously displaying the first referral and the second referral.

16. The system of claim 11, wherein receiving a request for a referral comprises receiving a request for a personal service provider.

17. The system of claim 11, wherein identifying the plurality of users comprises identifying the plurality of users based on demographic information.

18. The system of claim 11, wherein the processing equipment is further configured to perform operations comprising providing a communication channel between the first user and a service provider related to the request for the referral.

19. The system of claim 11, wherein the processing equipment is further configured to perform operations comprising providing the first user with an incentive from a service provider related to the request for the referral.

20. The system of claim 11, wherein providing the at least one referral to the first user comprises simultaneously displaying the at least one referral and at least one additional referral from the plurality of users that was received prior to receiving the request from the first user.
